(19) United States
(12) Patent Application Publication
(10) Pub. No.: US 2017/0346099 A1
(43) Pub. Date: Nov. 30, 2017

(54) LITHIUM BATTERY AND METHOD OF PREPARING PROTECTED ANODE

(71) Applicants: Samsung Electronics Co., Ltd., Suwon-si (KR); Samsung SDI Co., Ltd., Yongin-si (KR)

(72) Inventors: Hongsoo Choi, Seoul (KR); Yongsu Kim, Seongnam-si, Gyeonggi-do, (KR); Yonggun Lee, Suwon-si, Gyeonggi-do, (KR); Wonseok Chang, Seoul (KR)

(21) Appl. No.: 15/389,620

(22) Filed: Dec. 23, 2016

(30) Foreign Application Priority Data
May 27, 2016 (KR) 10-2016-0065692

(51) Int. Cl. H01M 4/62; H01M 4/38; H01M 10/0525; H01M 4/36; H01M 4/02

(52) U.S. Cl. CPC H01M 4/628; H01M 10/0525; H01M 4/366; H01M 4/382; H01M 2004/027

(57) ABSTRACT

A lithium battery includes: an anode including a lithium metal or a lithium alloy; an ion-conductive amorphous metal nitride layer disposed on a surface of the anode; a liquid electrolyte; and a cathode.

### CROSS-REFERENCE TO RELATED APPLICATION

This application claims the benefit of and priority to Korean Patent Application No. 10-2016-0065692, filed on May 27, 2016, in the Korean Intellectual Property Office, and all the benefits accruing therefrom under 35 U.S.C. §119, the content of which is incorporated herein in its entirety by reference.

### BACKGROUND

### 1. Field

The present disclosure relates to a lithium battery and methods of preparing a protected anode.

### 2. Description of the Related Art

Lithium batteries, such as lithium secondary batteries, are high-performance secondary batteries having the highest energy density among commercially available secondary batteries. Lithium secondary batteries may be used in various fields such as electric vehicles and energy storage. Recently, research into lithium secondary batteries operating at a high voltage has been performed.

Towards the manufacture of lithium secondary batteries, research has been directed towards increasing charge storage capacity by applying a lithium metal, which has a theoretical capacity of about 3,840 mAh/g, or a lithium alloy, to an anode has been carried out and research into utilizing the lithium secondary batteries at a high voltage has been performed.

Nonetheless, there remains a need for an improved anode having a lithium metal or a lithium alloy, a lithium battery including the same, and a method of preparing a protected anode.

### SUMMARY

Provided is a lithium battery including a protected anode.

Provided is a method of preparing a protected anode.

Provided is a protected anode.

Additional aspects will be set forth in part in the description which follows and, in part, will be apparent from the description.

According to an aspect of an embodiment, a lithium battery includes: an anode including a lithium metal or a lithium alloy; an ion-conductive amorphous metal nitride layer disposed on a surface of the anode; a liquid electrolyte; and a cathode.

According to an aspect of another embodiment, a method of preparing a protected anode includes: introducing an inert gas and an oxocarbon gas into a container in which an anode including the lithium metal or the lithium alloy is disposed to provide a compound represented by Formula 2 on at least a portion of a surface of the anode; and exposing the anode, which includes the lithium metal or the lithium alloy and including the compound represented by Formula 2 on the at least a portion of the surface thereof, to a nitrogen gas to prepare a protected anode including an ion-conductive amorphous metal nitride layer on a surface thereof:

Li₂₋ₐCO_{3-b} Formula 2

where 0≦a<1 and 0≦b<1.

According to an aspect of another embodiment, a protected anode includes an anode including a lithium metal or a lithium alloy; and an ion-conductive amorphous metal nitride layer disposed on a surface of the anode.

### BRIEF DESCRIPTION OF THE DRAWINGS

These and/or other aspects will become apparent and more readily appreciated from the following description of the embodiments, taken in conjunction with the accompanying drawings in which:

FIG. 1A is a schematic top view of a structure of a protected anode according to an embodiment;

FIG. 1B is a schematic top view of a structure of a protected anode according to an embodiment;

FIG. 1C is a schematic top view of a structure of a protected anode prepared according to Comparative Example 1;

FIG. 2A is a schematic cross-sectional view of a structure of a lithium secondary battery according to an embodiment;

FIG. 2B is a schematic cross-sectional view of a structure of a lithium secondary battery prepared according to Comparative Example 5;

FIG. 3 is a schematic diagram of a structure of a lithium metal battery according to an embodiment;

FIG. 4 is a graph of intensity (arbitrary units, a.u.) versus diffraction angle (degrees 2θ) and illustrates X-ray diffraction (XRD) analysis results of a protected anode and an anode of lithium secondary batteries (full cells) prepared according to Reference Example 1, Example 4, and Comparative Example 2;

FIGS. 5A and 5B are graphs of intensity (a.u.) versus binding energy (electron volts, eV) and illustrate S2p spectra, as X-ray Photoelectron Spectroscopy (XPS) analysis results, of the surfaces of the protected anode and the anode of the lithium secondary batteries (full cells) prepared according to Example 4 and Comparative Example 2, respectively;

FIGS. 6A and 6B are graphs of intensity (a.u.) versus binding energy (eV) and illustrate Li1s and N1s spectra, respectively, as XPS analysis results, of the surface of the protected anode of the lithium secondary battery (full cell) prepared according to Example 4;

FIGS. 6C and 6D are graphs of intensity (a.u.) versus binding energy (eV) and illustrate Li1s and N1s spectra, respectively, as XPS analysis results, of the surface of the anode of the lithium secondary battery (full cell) prepared according to Comparative Example 2;

FIG. 7A is a graph of imaginary resistance (Z″, ohms) versus real resistance (Z′, ohms) and illustrates the impedance characteristics of the lithium secondary batteries (full cells) prepared according to Examples 4 to 6 and Comparative Example 2 at 25° C.;

FIG. 7B is a histogram showing the bulk resistance (ohms) and the charge transfer resistance (ohms) of the protected anode and the anode of the lithium secondary batteries (full cells) prepared according to Examples 4 to 6 and Comparative Example 2 at 25° C.;

FIG. 7C is a graph of imaginary resistance (Z″, ohm) versus real resistance (Z′, ohms) and illustrates the impedance characteristics of the lithium secondary batteries (full cells) prepared according to Example 4 and Comparative Examples 2 and 4 at 25° C.;

FIG. 7D is a histogram showing the bulk resistance (ohms) and the charge transfer resistance (ohms) of the protected anode and the anode of the lithium secondary batteries (full cells) prepared according to Example 4 and Comparative Examples 2 and 4 at 25° C.;

FIG. 7E is a graph of imaginary impedance (Z″, ohms) versus real impedance (Z′, ohms) and illustrates the impedance characteristics of the lithium secondary batteries (full cells) prepared according to Example 4 and Comparative Example 5 at 25° C.;

FIG. 7F is histogram showing the bulk resistance and the charge transfer resistance of the protected anodes of the lithium secondary batteries (full cells) prepared according to Example 4 and Comparative Example 5 at 25° C.;

FIG. 8A is a graph of discharge capacity (milliampere hours, mAh) and coulombic efficiency (%) versus cycle number (n) illustrating the coulombic efficiency and discharge capacity of the lithium secondary batteries (full cells) prepared according to Example 7 and Comparative Example 3; and

FIG. 8B is a graph of discharge capacity (milliampere hours, mAh) and coulombic efficiency (%) versus cycle number (n) v illustrating the coulombic efficiency and discharge capacity of the lithium secondary batteries (full cells) prepared according to Example 4 and Comparative Example 2 according to the number of cycles.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. “Or” means “and/or.” Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

A C-rate is a measure of the rate, or the constant current, at which a battery is charged/discharged relative to its maximum capacity. A 1C rate means that the charge/discharge current will charge/discharge the entire battery in 1 hour.

Hereinafter, a lithium battery and a method of preparing a protected anode according to an embodiment will be described in further detail with reference to the accompanying drawings.

Throughout the specification, it will also be understood that when a component “includes” an element, unless there is another opposite description thereto, it should be understood that the component does not exclude another element but may further include another element.

### Lithium Battery Including a Protected Anode

A lithium battery operating under a high voltage environment (at about 4 V or greater) may provide a theoretically large energy source. However, the lithium battery may be highly reactive with moisture, oxygen, and materials constituting the electrolyte. Due to this reactivity, an irreversible layer may be formed on the surface of a lithium metal or lithium alloy anode and the cycle characteristics of the lithium battery may deteriorate.

For example, the decomposition products of an electrolyte may be generated on the surface of a cathode via oxidation with a lithium salt under high voltage operation and lithium ions may be reduced on the surface of a lithium metal or lithium alloy to form a lithium dendrite and an irreversible layer simultaneously with the formation of a solid electrolyte interphase (SEI) layer.

Thus, there is a need to develop a technique to reduce an undesired reaction between the lithium metal or lithium alloy anode and the decomposition products of the electrolyte on the surface of the lithium metal or lithium alloy anode. For example, a polymer protective layer or a metal oxide layer may be applied to the surface of the lithium metal or lithium alloy. However, these layers may be insufficient to improve the performance of lithium batteries under a high voltage operation environment.

Disclosed is a lithium battery including a protected anode in consideration of the aforementioned properties.

A lithium battery according to an embodiment includes: an anode including a lithium metal or a lithium alloy; a liquid electrolyte; and a cathode. The anode may be a protected anode including an ion-conductive amorphous metal nitride layer disposed on a surface of the anode including the lithium metal or lithium alloy.

The ion-conductive amorphous metal nitride layer may delay the reduction reaction of decomposition products of the electrolyte, which are understood to be formed on the surface of the cathode under a high voltage operation environment, and on the surface of the anode including the lithium metal or lithium alloy. Thus, since formation of an irreversible SEI layer may be inhibited or delayed on the surface of the lithium metal or lithium alloy anode, the performance of the lithium battery under a high voltage operation environment (at about 4 V or higher), may be improved. For example, ion conductivity and charge/discharge characteristics of the lithium battery at room temperature (25° C.) may be improved.

The ion-conductive amorphous metal nitride layer may contact the anode including the lithium metal or lithium alloy.

The ion-conductive amorphous metal nitride layer may be introduced in-situ onto the surface of the anode including the lithium metal or lithium alloy to inhibit direct contact between the electrolyte and the anode including the lithium metal or lithium alloy. Thus, reduction of the decomposition products of the electrolyte may be decreased at the surface of the anode including the lithium metal or lithium alloy anode. Formation of the irreversible SEI layer on the surface of the anode may be inhibited or delayed. As a result, the charge transfer resistance and the bulk resistance may be reduced under a high voltage operation environment at room temperature (25° C.) on the surface of the protected anode, and thus the ion conductivity and charge/discharge characteristics may be improved.

Throughout the specification, the term “charge transfer resistance” refers to resistance caused when the electrolyte and the (protected) anode exchange charges.

Throughout the specification, the term “bulk resistance” refers to resistance between the cathode and the (protected) anode.

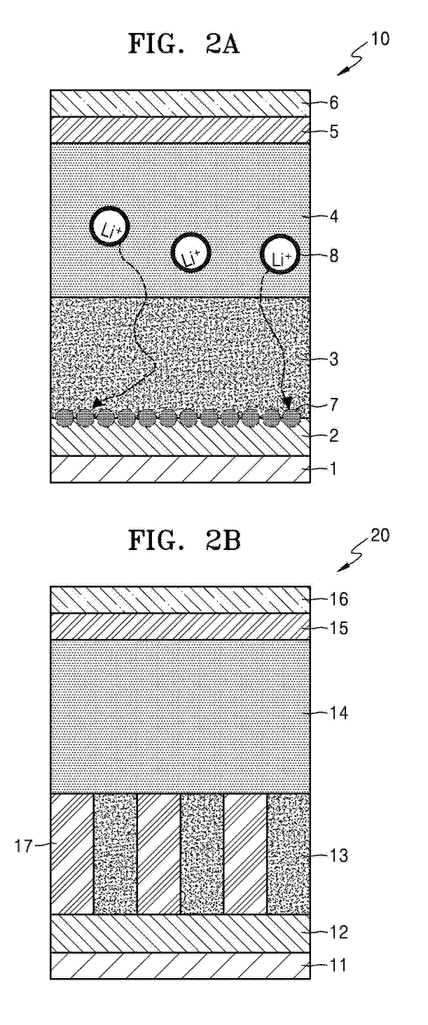

A method of forming a metal nitride layer on the surface of an the lithium metal or lithium alloy anode by adding an additive such as LiNO₃ to an electrolyte may inhibit direct contact between the electrolyte and the lithium metal or lithium alloy anode. A lithium battery, for example, a lithium secondary battery 20, prepared according to the method described above, includes a lithium metal or lithium alloy anode 12 provided with a metal nitride layer 13 formed on an anode current collector 11, an electrolyte 14 including LiNO₃, and a cathode active material layer 15 formed on a cathode current collector 16, as illustrated in FIG. 2B.

Since the metal nitride layer 13 may be formed on a portion of the surface of the lithium metal or lithium alloy anode 12 rather than on the entire surface thereof, the metal nitride layer 13 may be insufficient to inhibit direct contact between the electrolyte 14 and the lithium metal or lithium alloy anode 12. It may be difficult to inhibit and delay formation of the irreversible SEI layer 17 on the surface of the lithium metal or lithium alloy anode 12. Thus, the metal nitride layer 13 may not serve as a desirable protective layer for the lithium metal or lithium alloy anode 12. A lithium battery including the anode may not have suitable ion conductivity and charge/discharge characteristics when operated under a high voltage operation environment.

The ion-conductive amorphous metal nitride layer may be a protective layer covering the entire surface of the anode including the lithium metal or lithium alloy.

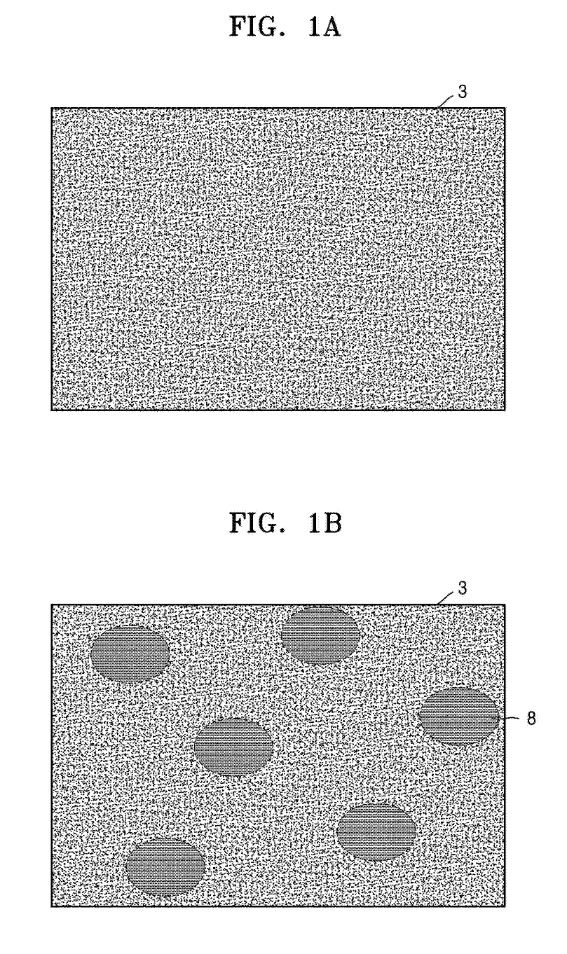

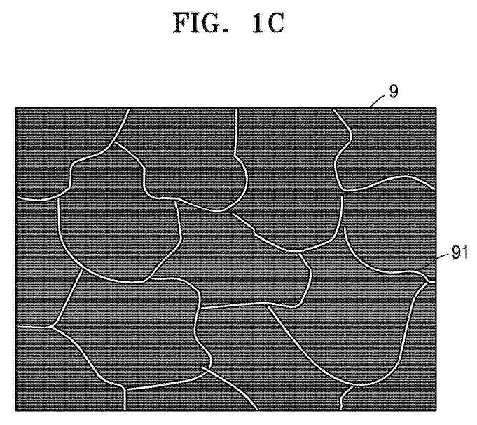

The ion-conductive amorphous metal nitride layer may be a layer covering the entire surface of the anode including the lithium metal or lithium alloy with a uniform thickness, as illustrated in FIG. 1A, and serve as a protective layer inhibiting direct contact between the electrolyte and the anode including the lithium metal or lithium alloy.

In contrast to an ion-conductive amorphous metal nitride layer, a crystalline metal nitride layer 9 may have a grain boundary 91 between adjacent domains of the surface of the anode including the lithium metal or lithium alloy, as illustrated in FIG. 1C. Thus, the crystalline metal nitride layer may be insufficient to inhibit direct contact between the electrolyte and the anode including the lithium metal or lithium alloy, compared with the ion-conductive amorphous metal nitride layer. Since charge transfer resistance and bulk resistance may not be sufficiently reduced on the surface of the anode under high voltage operation at room temperature (25° C.), ion conductivity and charge/discharge characteristics may deteriorate.

The ion-conductive amorphous metal nitride layer may have a thickness of about 1 nanometer (nm) to about 15 micrometers (μm), for example, about 1 nm to about 14 μm, for example, about 1 nm to about 13 μm, for example, about 1 nm to about 12 μm, for example, about 1 nm to about 11 μm, for example, about 1 nm to about 10 μm, for example, about 1 nm to about 9 μm, for example, about 1 nm to about 8 μm, for example, about 1 nm to about 7 μm, for example, about 1 nm to about 6 μm, for example, about 1 nm to about 5 μm, for example, about 1 nm to about 4 μm, for example, about 1 nm to about 3 μm, for example, about 1 nm to about 2 μm, and for example, about 1 nm to about 1 μm.

When the thickness of the ion-conductive amorphous metal nitride layer is within this range, the reduction of the decomposition products of the electrolyte may be delayed on the surface of the protected anode including the protective layer and ion conductivity and charge/discharge characteristics may be sufficiently maintained under a high voltage operation environment at room temperature (25° C.).

The protected anode including the ion-conductive amorphous metal nitride layer may have a thickness of about 100 nm to about 30 μm.

The ion-conductive amorphous metal nitride layer may include a metal nitride represented by Formula 1 below.

LiₓN Formula 1

In Formula 1, 0.01≦x≦3.

The metal nitride represented by Formula 1 has high ion conductivity at room temperature (e.g., 25° C.), and accordingly, the protected anode including the same may have improved ion conductivity and charge/discharge characteristics under a high voltage operation environment at room temperature (25° C.).

Examples of the anode including the lithium metal or lithium alloy may include a lithium metal or an alloy of lithium and aluminum, tin, magnesium, indium, calcium, titanium, vanadium, sodium, potassium, rubidium, cesium, strontium, barium, or the like.

The lithium metal or lithium alloy may include a compound represented by Formula 2 below that is disposed on at least one portion of the surface thereof.

Li₂₋ₐCO_{3-b} Formula 2

In Formula 2, 0≦a<1 and 0≦b<1.

The compound 7 represented by Formula 2 (oval shapes with dashed lines) may be included in at least one portion of the surface of the lithium metal or lithium alloy anode, as illustrated in FIG. 1B.

The ion-conductive amorphous metal nitride layer may be disposed on the surface of the lithium metal or lithium alloy anode including the compound represented by Formula 2 above.

The lithium battery, for example, a lithium secondary battery 10, includes a protected anode formed by disposing a lithium metal or lithium alloy anode 2 on an anode current collector 1 and an ion-conductive amorphous metal nitride layer 3 on the surface thereof, an electrolyte 4, and a cathode active material layer 5 on a cathode current collector 6, as illustrated in FIG. 2A. The lithium metal or lithium alloy anode 2 includes the compound 7 (circles with dashed lines), which may be represented by Formula 2, disposed on a portion of the surface of the lithium metal or lithium alloy anode 2 and between the lithium metal or lithium alloy anode 2 and the ion-conductive amorphous metal nitride layer 3. Lithium cations (Li⁺) 8 may transfer to the protected anode including the ion-conductive amorphous metal nitride layer 3 via the electrolyte 4.

Since the lithium metal or lithium alloy anode 2 includes the compound 7 represented by Formula 2 on a portion of the surface thereof, the ion-conductive amorphous metal nitride layer 3 may be formed on the surface of the lithium metal or lithium alloy anode 2 and the compound 8, which is represented by Formula 2, formed between the lithium metal or lithium alloy anode 2 and the ion-conductive amorphous metal nitride layer 3.

The amount of the compound 8, which is represented by Formula 2, may be in the range of about 0.1 mole percent (mol %) to about 5 mol %, for example, about 0.1 mol % to about 4 mol %, and for example, about 0.1 mol % to about 3 mol %, based on 100 mol % of all molecules at the surface of the lithium metal or lithium alloy anode 2.

The molecules at the surface of the lithium metal or lithium alloy may include Li, C, O, S, H, or any combination thereof. Examples of the molecules may be Li₂O₂, Li₂O, Li₂S, Li₂CO₃, or Li₂SO₃.

When the amount of the compound represented by Formula 2 is within this range, the strength of the ion-conductive amorphous metal nitride layer 3 may be maintained during repeated charging and discharging cycles of the lithium battery, and the protected anode including the same may have improved ion conductivity and charge/discharge characteristics under a high voltage operation environment at room temperature (25° C.).

The electrolyte 4 may be a liquid electrolyte including a non-aqueous organic solvent and a lithium salt.

The non-aqueous organic solvent may include at least one selected from a carbonate solvent, an ester solvent, an ether solvent, a ketone solvent, an amine solvent, and a phosphine solvent.

The carbonate organic solvent may be dimethyl carbonate (DMC), diethyl carbonate (DEC), ethyl methyl carbonate (EMC), dipropyl carbonate (DPC), methyl propyl carbonate (MPC), ethyl propyl carbonate (EPC), ethylene carbonate (EC), fluoroethylene carbonate (FEC), propylene carbonate (PC), butylene carbonate (BC), or the like.

The ester organic solvent may be methyl acetate, ethyl acetate, n-propyl acetate, dimethyl acetate, methyl propionate, ethyl propionate, γ-butyrolactone, decanolide, valerolactone, mevalonolactone, caprolactone, or the like.

The ether organic solvent may be dimethyl ether, diethyl ether, tetrafluoropropyl ether, dibutyl ether, tetraglyme, diglyme, dimethoxyethane, 2-methyltetrahydrofuran, or tetrahydrofuran, or the like.

The ketone organic solvent may be cyclohexanone, or the like.

The amine organic solvent may be trimethyl amine, triphenyl amine, or the like.

The phosphine organic solvent may be triethyl phosphine. However, the embodiments are not limited thereto, and any suitable non-aqueous organic solvents, including those in the art, may also be used.

In some embodiments, the non-aqueous organic solvent may be a nitrile such as R—CN (where R is a substituted or unsubstituted C₂-C₃₀ linear, branched, or cyclic hydrocarbon group that may include a double-bond, an aromatic ring, or an ether bond), amides such as dimethylformamide, dioxolanes such as 1,3-dioxolane, and sulfolanes.

The term “substituted” as used herein means substitution with a halogen atom, a C₁-C₂₀ alkyl group substituted with a halogen atom (e.g., CCF₃, CHCF₂, CH₂F, CCl₃, or the like), a C₁-C₂₀ alkoxy group, a C₂-C₂₀ alkoxyalkyl group, a hydroxyl group, a nitro group, a cyano group, an amino group, an amidino group, a hydrazine, a hydrazone, a carboxyl group or a salt thereof, a sulfonyl group, a sulfamoyl group, a sulfonic acid or a salt thereof, a phosphoric acid or a salt thereof, a C₁-C₂₀ alkyl group, a C₂-C₂₀ alkenyl group, a C₂-C₂₀ alkynyl group, a C₁-C₂₀ heteroalkyl group, a C₆-C₂₀ aryl group, a C₆-C₂₀ arylalkyl group, a C₆-C₂₀ heteroaryl group, a C₇-C₂₀ heteroarylalkyl group, a C₆-C₂₀ heteroaryloxy group, a C₆-C₂₀ heteroaryloxyalkyl group, or a C₆-C₂₀ heteroarylalkyl group.

The term “halogen atom” as used herein includes fluorine, bromine, chlorine, iodine, and the like.

The term “alkyl” used herein refers to a fully saturated branched or unbranched (straight chain or linear) hydrocarbon group. Non-limiting examples of “alkyl” include methyl, ethyl, n-propyl, isopropyl, n-butyl, isobutyl, sec-butyl, n-pentyl, isopentyl, neopentyl, iso-amyl, n-hexyl, 3-methylhexyl, 2,2-dimethylpentyl, 2,3-dimethylpentyl, and n-heptyl.

The terms “alkoxy” and “aryloxy” respectively mean alkyl or aryl bound to an oxygen atom.

The term “alkenyl” as used herein refers to a branched or unbranched hydrocarbon group having at least one carbon-carbon double bond. Non-limiting examples of the alkenyl group include vinyl, allyl, butenyl, isopropenyl, and isobutenyl.

The term “alkynyl” as used herein refers to a branched or unbranched hydrocarbon group having at least one carbon-carbon triple bond. Non-limiting examples of the alkynyl group include ethynyl, butynyl, isobutynyl, and isopropynyl.

The term “aryl” as used herein also includes a group with an aromatic ring fused to at least one carbocyclic group. Non-limiting examples of the aryl group include phenyl, naphthyl, and tetrahydronaphthyl.

The term “heteroaryl” as used herein indicates a monocyclic or bicyclic organic compound including at least one heteroatom selected from N, O, P, and S, wherein the rest of the cyclic atoms are all carbon. The heteroaryl group may include, for example, one to five heteroatoms and may include five- to ten-membered rings. In the heteroaryl group, S or N may be present in various oxidized forms.

Non-limiting examples of the heteroaryl group include thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, 1,3,4-oxadiazolyl, 1,2,3-thiadiazolyl, 1,2,4-thiadiazolyl, 1,2,5-thiadiazolyl, 1,3,4-thiadiazolyl, isothiazol-3-yl, isothiazol-4-yl, isothiazol-5-yl, oxazol-2-yl, oxazol-4-yl group, an oxazol-5-yl group, an isoxazol-3-yl group, an isoxazol-4-yl group, an isoxazol-5-yl, 1,2,4-triazol-3-yl, 1,2,4-triazol-5-yl, 1,2,3-triazol-4-yl, 1,2,3-triazol-5-yl, tetrazolyl, pyrid-2-yl, pyrid-3-yl, 2-pyrazin-2-yl, pyrazin-4-yl, pyrazin-5-yl, 2-pyrimidin-2-yl, 4-pyrimidin-2-yl, and 5-pyrimidin-2-yl.

The term “carbocyclic” as used herein refers to saturated or partially unsaturated non-aromatic monocyclic, bicyclic or tricyclic hydrocarbon groups. Non-limiting examples of the monocyclic hydrocarbon groups include cyclopentyl, cyclopentenyl, cyclohexyl, and cyclohexenyl. Non-limiting examples of the bicyclic hydrocarbon groups include bornyl, decahydronaphthyl, bicyclo[2.1.1]hexyl, bicyclo[2.2.1]heptyl, bicyclo[2.2.1]heptenyl, and bicyclo[2.2.2]octyl. The tricyclic hydrocarbon groups may be, for example, adamantyl and the like.

The term “heterocyclic” as used herein refers to a cyclic hydrocarbon group having at least one heteroatom and 5 to 20 carbon atoms, for example, 5 to 10 carbon atoms. In this regard, the heteroatom may be one selected from sulfur, nitrogen, oxygen, and boron.

The non-aqueous organic solvent may be used alone or in a combination of two or more. In the latter case, a mixing ratio of the non-aqueous organic solvents may be appropriately adjusted depending on performance of the battery, as would be known to one of ordinary skill in the art without undue experimentation.

Examples of the non-aqueous organic solvent may be an ether solvent, a carbonate solvent, or a combination thereof. For example, the non-aqueous organic solvent may be an ether organic solvent.

When the ether organic solvent or any combination including the ether solvent has a higher potential window than other non-aqueous organic solvents, a lithium battery including an electrolyte having the ether solvent or any combination including the ether solvent may have improved ion conductivity and charge/discharge characteristics under a high voltage operation environment at room temperature (25° C.).

The lithium salt may include a lithium salt represented by Formula 3 below.

LiX₁ Formula 3

In Formula 3, X₁ may include at least one anion selected from BF₄⁻, PF₆⁻, AsF₆⁻, SbF₆⁻, AlCl₄⁻, HSO₄⁻, CH₃SO₃⁻, (CF₃SO₂)₂N⁻, Cl⁻, Br⁻, I⁻, SO₄⁻, PF₆⁻, ClO₄⁻, F₃SO₃⁻, CF₃CO₂⁻, C₂F₅SO₂)₂N⁻, (C₂F₅SO²)(CF₃SO₂)N⁻, CF₃SO₂)₂N⁻, NO₃⁻, Al₂Cl₇⁻, ASF₆⁻, SbF₆⁻, CH₃COO⁻, (CF₃SO₂)₃C⁻, (CF₃)₂PF₄⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, and (O(CF₃)₂C₂(CF₃)₂O)₂PO⁻.

In the electrolyte 4, the lithium salt may have a concentration of about 0.1 moles per liter (M) to about 2.0 M.

In some embodiments, the electrolyte 4 may further include an additive. For example, the electrolyte 4 may include vinylene carbonate (VC), catechol carbonate (CC), and the like to form and maintain a solid electrolyte interface (SEI) layer on the surface of the anode. The electrolyte 4 may further include a redox-shuttle-type additive such as n-butyl ferrocene and a halogen-substituted benzene to prevent overcharging. The electrolyte 4 may further include a film-forming additive such as cyclohexyl benzene and biphenyl. The electrolyte 4 may further include a cation receptor such as a crown ether-based compound and an anion receptor such as a boron-based compound to improve conductivity. The electrolyte 4 may further include a phosphate-based compound such as trimethyl phosphate (TMP), tris(2,2,2-trifluoroethyl) phosphate (TFP), and hexamethoxycyclotriphosphazene (HMTP) as a flame retardant.

If desired, the electrolyte 4 may further include an ionic liquid.

Examples of the ionic liquid may include compounds that include cations such as linear or branched substituted ammonium, imidazolium, pyrrolidinium, and piperidinium, and anions such as PF₆⁻, BF₄⁻, CF₃SO₃⁻, (CF₃SO₂)₂N⁻, (C₂F₅SO₂)₂N⁻, (C₂F₅SO₂)₂N⁻, and (CN)₂N⁻.

In a Nyquist plot of the lithium battery, obtained by measuring impedance, the charge transfer resistance between the protected anode and the electrolyte may be less than that between the anode including the lithium metal or lithium alloy and the electrolyte when the ion-conductive amorphous metal nitride layer is not present by about 10% or greater, for example, by about 10% to about 200%, about 15% to about 175%, or about 20% to about 150%, based on the charge transfer resistance between the protected anode and the electrolyte at 25° C.

In the Nyquist plot of the lithium battery, obtained by measuring impedance, the bulk resistance between the protected anode and the cathode may be less than that between the anode including the lithium metal or lithium alloy and the cathode when the ion-conductive amorphous metal nitride layer is not present by about 10% or greater, for example, by about 10% to about 200%, about 15% to about 175%, or about 20% to about 150%, based on the bulk resistance between the protected anode and the cathode at 25° C.

The charge transfer resistance and bulk resistance are as defined above.

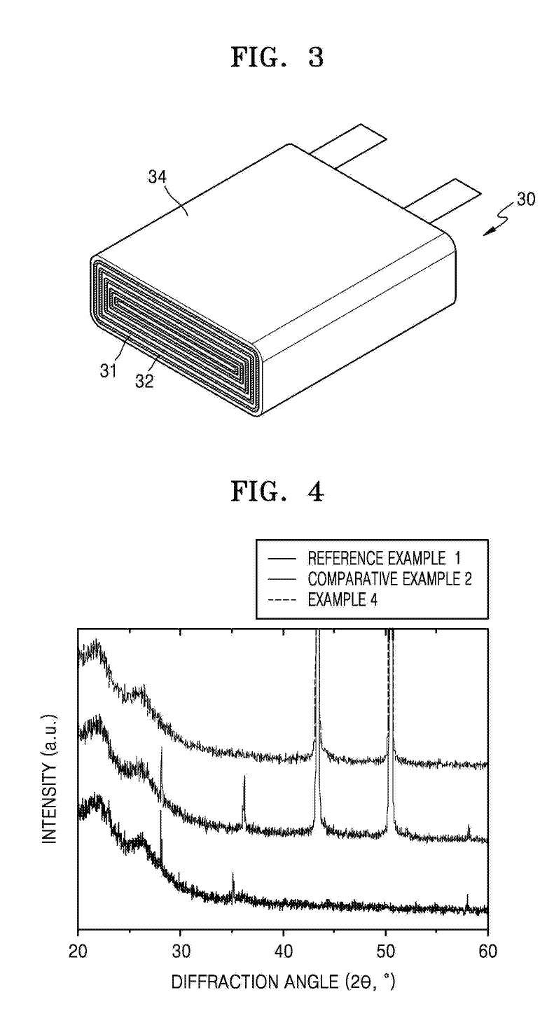

FIG. 3 schematically illustrates a structure of a lithium metal battery 30.

As illustrated in FIG. 3, the lithium metal battery 30 includes a cathode 31, an anode 32, and a battery can 34 that is configured to accommodate the cathode 31 and the anode 32.

The anode 32 may include the protected anode described above.

The cathode 31 may be prepared by coating a cathode active material on the surface of a cathode current collector formed of aluminum, or the like. Alternatively, the cathode 31 may be prepared by casting a cathode active material on a separate support and laminating a cathode active material film separated from the support on a current collector.

The cathode active material may include a compound allowing intercalation and deintercalation of lithium, an inorganic sulfur (S₈), or a sulfur-based compound.

For example, the compound allowing intercalation and deintercalation of lithium may be a compound represented by any one of formulae: LiₐA_{1-b}B′_{b}D′₂ (where 0.90≦a≦1.8 and 0≦b≦0.5); LiₐE_{1-b}B′_{b}O_{2-c}D′_{c} (where 0.90≦a≦1.8, 0≦b≦0.5, and 0≦c≦0.05); LiE_{2-b}B′_{b}O_{4-c}D′_{c} (where 0≦b≦0.5 and 0≦c≦0.05); LiₐNi_{1-b-c}Co_{b}B′_{c}D′_{α} (where 0.90≦a≦1.8, 0≦b≦0.5, 0≦c≦0.05, and 0<α≦2); LiₐNi_{1-b-c}Co_{b}B′_{c}O_{2-α}F′_{α} (where 0.90≦a≦1.8, 0≦b≦0.5, 0≦c≦0.05, and 0<α<2); LiₐNi_{1-b-c}Mn_{b}B′_{c}D′_{α} (where 0.90≦a≦1.8, 0≦b≦0.5, 0≦c≦0.05, and 0<α≦2); LiₐNi_{1-b-c}Mn_{b}B′_{c}O_{2-α}F′_{α} (where 0.90≦a≦1.8, 0≦b≦0.9, 0≦c≦0.05, and 0<α<2); LiₐNi_{b}E_{c}G_{d}O₂ (where 0.90≦a≦1.8, 0≦b≦0.9, 0≦c≦0.5, and 0.001≦d≦0.1); LiₐNi_{b}Co_{c}Mn_{d}GₑO₂ (where 0.90≦a≦1.8, 0≦b≦0.9, 0≦c≦0.5, 0≦d≦0.5, and 0.001≦e≦0.1); LiₐNiG_{b}O₂ (where 0.90≦a≦1.8 and 0.001≦b≦0.1); LiₐCoG_{b}O₂ (where 0.90≦a≦1.8 and 0.001≦b≦0.1); LiₐMnG_{b}O₂ (where 0.90≦a≦1.8 and 0.001≦b≦0.1); LiₐMn₂G_{b}O₄ (where 0.90≦a≦1.8 and 0.001≦b≦0.1); QO₂; QS₂; LiQS₂; V₂O₅; LiV₂O₅; LiI′O₂; LiNiVO₄; Li_{(3-f)}J₂(PO₄)₃(0≦f≦2); Li_{(3-f)}Fe₂(PO₄)₃(0≦f≦2); and LiFePO₄.

In the formulae, A is Ni, Co, Mn, or any combination thereof; B′ is Al, Ni, Co, Mn, Cr, Fe, Mg, Sr, V, a rare earth element or any combination thereof; D′ is O, F, S, P, or any combination thereof; E is Co, Mn, or any combination thereof; F′ is F, S, P, or any combination thereof; G is Al, Cr, Mn, Fe, Mg, La, Ce, Sr, V, or any combination thereof; Q is Ti, Mo, Mn, or any combination thereof; I′ is Cr, V, Fe, Sc, Y, or any combination thereof; and J is V, Cr, Mn, Co, Ni, Cu, or any combination thereof.

Examples of the sulfur-based compound may include at least one selected from a sulfide compound, an organosulfur compound, and a carbon-sulfur polymer. The sulfide compound may include Li₂Sₙ (where n≧1), 2,5-dimercapto-1,3,4-thiadiazole, 1,3,5-trithiocyanuric acid, or the like. Examples of the carbon-sulfur polymer may include C₂Sₓ (where x=2.5 to 50).

The cathode active material may further include a binder and a conductive material.

Examples of the binder include a polyethylene, a polypropylene, a polytetrafluorethylene (PTFE), a polyvinylidene difluoride (PVdF), a styrene-butadiene rubber, a tetrafluoroethylene-perfluoroalkylvinylether copolymer, a vinylidene fluoride-hexafluoropropylene copolymer, a vinylidene fluoride-chlorotrifluoroethylene copolymer, an ethylene-tetrafluoroethylene copolymer, a polychlorotrifluoroethylene, a fluorovinylidene-pentafluoropropylene copolymer, a propylene-tetrafluoroethylene copolymer, an ethylene-chlorotrifluoroethylene copolymer, a vinylidene fluoride-hexafluoropropylene-tetrafluoroethylene copolymer, a vinylidene fluoride-perfluoromethylvinylether-tetrafluoroethylene copolymer, and an ethylene-acrylic acid copolymer, which may be used alone or in combination. However, the binder is not limited thereto, and any material suitable for use as a binder, including those in the art, may also be used.

The conductive material may be: a carbonaceous material such as carbon black, graphite, natural graphite particulates, an artificial graphite, acetylene black, Ketjen black, a carbon fiber, and a carbon nanotube; a metal such as copper, nickel, aluminum, and silver, each of which may be used in powder, fiber, or tube form; and conductive polymers such as polyphenylene derivatives. However, the conductive material is not limited thereto, and any material suitable for use as a conductive material, including those in the art, may also be used.

In some embodiments, a cathode not including sulfur or organosulfur may be prepared and a catholyte prepared by adding a sulfur-containing cathode active material to an electrolyte may be used.

The electrolyte described above is disposed between the anode 32 and the cathode 31. The lithium metal battery 30 may further include a separator disposed between the anode 31, i.e., the protected anode, and the cathode 31. The separator may include a polyethylene, a polypropylene, or a polyvinylidene difluoride and have a multi-layered structure including two or more layers thereof. A mixed multi-layered structure such as a polyethylene/polypropylene double-layered separator, a polyethylene/polypropylene/polyethylene triple-layered separator, a polypropylene/polyethylene/polypropylene triple-layered separator, and the like may be used. An electrolyte including the lithium salt and the non-aqueous organic solvent described above may further be added to the separator.

The lithium metal battery 30 may be a unit cell having a cathode/separator/anode structure, a bi-cell having a cathode/separator/anode/separator/cathode structure, or a stacked battery having a repeated bi-cell or unit cell structure.

An operating voltage of the lithium battery may be about 4.0 V or greater, for example, about 4.1 V or greater, for example, about 4.2 V or greater, and for example, about 4.3 V or greater.

The lithium battery may be a lithium primary battery or a lithium secondary battery. The lithium battery may have various forms, and for example, may be in the form of a coin, a button, a sheet, a stack, a cylinder, a plane, or a horn. In some embodiments, the lithium battery may be applied to large-sized batteries used in electric vehicles.

### Method of Preparing Protected Anode

A method of preparing a protected anode, according to an embodiment, includes: including a compound represented by Formula 2 below to a portion of the surface of a lithium metal or lithium alloy anode by introducing an inert gas and oxocarbon gas into a container in which the lithium metal or lithium alloy anode is disposed; and preparing a protected anode by forming an ion-conductive amorphous metal nitride layer on the surface of the lithium metal or lithium alloy anode by exposing the lithium metal or lithium alloy anode including the compound represented by Formula 2 on a portion of the surface thereof to a nitrogen gas.

Li₂₋ₐCO_{3-b} Formula 2

In Formula 2, 0≦a<1 and 0≦b<1.

In an embodiment, the method of preparing the protected anode comprises introducing an inert gas and an oxocarbon gas into a container in which an anode comprising a lithium metal or a lithium alloy is disposed to provide a compound represented by Formula 2 on at least a portion of a surface of the anode; and exposing the anode, which comprises the lithium metal or the lithium alloy and the compound represented by Formula 2 on the at least a portion of the surface thereof, to a nitrogen gas to prepare the protected anode, wherein the protected anode comprises an ion-conductive amorphous metal nitride layer on a surface thereof.

First, a lithium metal or lithium alloy anode is prepared. In an exemplary embodiment, a lithium metal or lithium alloy ingot may be pressed on an anode current collector such as copper in a container, for example, a sealed container, to prepare the lithium metal or lithium alloy anode. Alternatively, a lithium metal or lithium alloy thin film anode may be prepared by deposition including precipitating a lithium metal or lithium alloy on a base material such as metal or plastic to form a film.

The inert gas and oxocarbon gas may be introduced into the container that includes the lithium metal or lithium alloy anode such that a portion of the surface of the lithium metal or lithium alloy anode includes, or becomes incorporated with, the compound represented by Formula 2. The inert gas may be nitrogen, helium, neon, argon, krypton, xenon, radon, or a combination thereof. The oxocarbon gas may be carbon monoxide (CO) gas or carbon dioxide (CO₂) gas including only carbon (C) and oxygen (O). Introduction of the inert gas and oxocarbon gas may be performed using a nozzle. For example, the inert gas and oxocarbon gas may be introduced into the sealed container by using the nozzle under a reduced pressure of about 10⁻⁴ Torr to about 10⁻² Torr.

The lithium metal or lithium alloy anode including the compound represented by Formula 2 on the surface thereof may have a stable anode surface since the compound functions as an insulating material at or covering the surface of the anode.

The lithium metal or lithium alloy anode including the compound represented by Formula 2 on the surface thereof, for example on a portion of the surface thereof, is exposed to a nitrogen gas to prepare the protected anode in which the ion-conductive amorphous metal nitride layer is disposed on the surface, for example the entire surface, of the lithium metal or lithium alloy anode. The ion-conductive amorphous metal nitride layer may contact the anode including the lithium metal or lithium alloy.

The method may include a process of exposing the lithium metal or lithium alloy anode including the compound represented by Formula 2 on the surface thereof to a nitrogen gas at a temperature of about 10° C. to about 20° C. for about 1 minute to about 120 minutes. A thickness of the ion-conductive amorphous metal nitride layer formed on the surface of the lithium metal or lithium alloy anode including the compound represented by Formula 2 may be controlled according to the exposure time to a nitrogen gas.

The protected anode may delay reduction of the decomposition products of the electrolyte that may be generated on the surface of the cathode under a high voltage operation environment, and/or on the surface of the anode including the lithium metal or lithium alloy. Accordingly, formation of the irreversible SEI layer may be inhibited and delayed on the surface of the anode including the lithium metal or lithium alloy, and thus performance of the lithium battery under a high voltage operation environment, i.e., ion conductivity and charge/discharge characteristics at room temperature (25° C.), may be improved.

The ion-conductive amorphous metal nitride layer may include a metal nitride represented by Formula 1 below.

LiₓN Formula 1

In Formula 1, 0.01≦x≦3.

The metal nitride represented by Formula 1 has a desirable ion conductivity at room temperature, and the protected anode including the same may have a suitable ion conductivity and charge/discharge characteristics under a high voltage operation environment at room temperature (25° C.).

The ion-conductive amorphous metal nitride layer may have a thickness of about 1 nm to about 15 μm.

The ion-conductive amorphous metal nitride layer may have a thickness of about 1 nm to about 14 μm, for example, about 1 nm to about 13 μm, for example, about 1 nm to about 12 μm, for example, about 1 nm to about 11 μm, for example, about 1 nm to about 10 μm, for example, about 1 nm to about 9 μm, for example, about 1 nm to about 8 μm, for example, about 1 nm to about 7 μm, for example, about 1 nm to about 6 μm, for example, about 1 nm to about 5 μm, for example, about 1 nm to about 4 μm, for example, about 1 nm to about 3 μm, for example, about 1 nm to about 2 μm, and for example, about 1 nm to about 1 μm.

When the thickness of the ion-conductive amorphous metal nitride layer is within this range, reduction of the decomposition products of the electrolyte on the protected anode including the protective layer may be delayed and ion conductivity and charge/discharge characteristics may be improved under a high voltage operation environment at room temperature (25° C.).

Hereinafter, one or more embodiments will be described in detail with reference to the following examples and comparative examples. These examples and comparative examples are not intended to limit the purpose and scope of the one or more embodiments of the present invention.

### EXAMPLES

### Example 1: Preparation of Protected Anode

A lithium metal ingot was pressed on a copper current collector in a sealed container at a pressure of about 10⁻³ Torr while supplying argon gas and CO₂ gas at a volume ratio of 85:15 to prepare a lithium metal anode having a thickness of about 20 μm in which lithium metal is disposed on the copper current collector (Honjo Chemical, Japan).

About 3 mol % of Li₂CO₃, based on 100 mol % of molecules at the surface of the lithium metal anode, was formed on a portion of the surface of the lithium metal anode.

Then, the lithium metal anode on which Li₂CO₃ was partially formed was exposed to a nitrogen gas (from which moisture was removed) for about 60 minutes to prepare a protected anode in which an amorphous LiₓN layer (where 0.01≦x≦3) having a thickness of 6 μm is formed on the lithium metal anode.

### Example 2: Preparation of Protected Anode

A protected anode in which the amorphous LiₓN layer (where 0.01≦x≦3) having a thickness of about 1 μm is formed on the lithium metal anode was prepared in the same manner as in Example 1, except that the lithium metal anode was exposed to a nitrogen gas from which moisture was removed for about 15 minutes instead of 60 minutes.

### Example 3: Preparation of Protected Anode

A protected anode in which the amorphous LiₓN layer (where 0.01≦x≦3) having a thickness of 12 μm is formed on the lithium metal anode was prepared in the same manner as in Example 1, except that the lithium metal anode was exposed to a nitrogen gas from which moisture was removed for about 120 minutes instead of 60 minutes.

### Comparative Example 1: Preparation of Protected Anode

A lithium metal ingot was pressed on a copper current collector to prepare a lithium metal anode having a thickness of about 100 μm in which lithium metal is disposed on the copper current collector (Honjo Chemical, Japan). Then, a film formed on the lithium metal was completely removed by using a brush and the lithium metal anode was re-pressed to improve the flatness of the surface. The lithium metal anode was exposed to a nitrogen gas from which moisture was removed for about 60 minutes to prepare a protected anode in which a crystalline LiₓN layer (where 0.01≦x≦3) having a thickness of about 6 μm is formed on the lithium metal anode.

### Example 4: Preparation of Lithium Secondary Battery (Full Cell)

The protected anode was prepared according to Example 1. Separately, LiCoO₂, a conductive material (Super-P; Timcal Ltd.), polyvinylidene fluoride (PVdF), and N-pyrrolidone were mixed to prepare a cathode composition. In the cathode composition, a weight ratio of LiCoO₂, the conductive material, and PVDF was 97:1.5:1.5.

The cathode composition was coated on an aluminum foil (where thickness: about 15 μm) and dried at 25° C. The dried resultant was dried in a vacuum at about 110° C. to prepare a cathode. The cathode has a capacity of 3.5 milliampere hours per square centimeter (mAh/cm²).

A polyethylene/propylene separator was interposed between the cathode and the protected anode obtained as described above, and a liquid electrolyte was injected thereinto to prepare a lithium secondary battery (full cell). The liquid electrolyte was prepared by dissolving lithium bis(fluorosulfonyl)imide (LiFSI), as a lithium salt, in a mixed solvent of dimethyl ether (DME) and tetrafluoropropyl ether (TTE) in a volume ratio of 16:84 at a molarity of 0.92 M.

### Example 5: Preparation of Lithium Secondary Battery (Full Cell)

A lithium secondary battery (full cell) was prepared in the same manner as in Example 4, except that the protected anode prepared according to Example 2 was used instead of the protected anode prepared according to Example 1.

### Example 6: Preparation of Lithium Secondary Battery (Full Cell)

A lithium secondary battery (full cell) was prepared in the same manner as in Example 4, except that the protected anode prepared according to Example 3 was used instead of the protected anode prepared according to Example 1.

### Example 7: Preparation of Lithium Secondary Battery (Full Cell)

A lithium secondary battery (full cell) was prepared in the same manner as in Example 4, except that a liquid electrolyte was prepared by dissolving LiPF₆, as a lithium salt, in a mixed solvent of fluoroethylene carbonate (FEC) and diethyl carbonate (DEC) in a volume ratio of 40:60 at a molarity of 1.3 M instead of the liquid electrolyte prepared by dissolving of LiFSI in the mixed solvent of DME and TTE in a volume ratio of 16:84 at the molarity of 0.92 M.

### Comparative Example 2: Preparation of Lithium Secondary Battery (Full Cell)

A lithium secondary battery (full cell) was prepared in the same manner as in Example 4, except that a lithium metal anode having a thickness of about 20 μm was used instead of the protected anode prepared according to Example 1.

### Comparative Example 3: Preparation of Lithium Secondary Battery (Full Cell)

A lithium secondary battery (full cell) was prepared in the same manner as in Example 7, except that a lithium metal anode having a thickness of about 20 μm was used instead of the protected anode prepared according to Example 1.

### Comparative Example 4: Preparation of Lithium Secondary Battery (Full Cell)

A lithium secondary battery (full cell) was prepared in the same manner as in Example 4, except that a lithium metal anode having a thickness of about 20 μm was used as the anode instead of the protected anode prepared according to Example 1, the liquid electrolyte prepared by dissolving LiFSI, as the lithium salt, in the mixed solvent of DME and TTE in the volume ratio of 16:84 at the molarity of 0.92 M was used, and 5% by weight of LiNO₃ additive based on 100% by weight of a total weight of the liquid electrolyte was used.

### Comparative Example 5: Preparation of Lithium Secondary Battery (Full Cell)

A lithium secondary battery (full cell) was prepared in the same manner as in Example 4, except that the protected anode prepared according to Comparative Example 1 was used instead of the protected anode prepared according to Example 1.

### Analysis Example 1: X-ray Diffraction (XRD)

A polyimide (PI) tape was used as Reference Example 1. The protected anode and the anode of the lithium secondary batteries (full cells) prepared according to Example 4 and Comparative Example 2 were respectively adhered to top surfaces of the PI tapes, and X-ray diffraction (XRD) experiments were performed thereon. The results are shown in FIG. 4.

A Rigaku RINT2200HF+ diffractometer using CuK α radiation (1.540598 Å) was used as an XRD diffractometer.

Referring to FIG. 4, no peak was observed for the protected anode of the lithium secondary battery (full cell) prepared according to Example 4 at a diffraction angle (2θ) ranging from about 35° to about 38°, which is different from the anode of the lithium secondary battery (full cell) prepared according to Comparative Example 2. Peaks at the diffraction angle (2θ) ranging from about 35° to about 38° provide information about the lithium on the surface of the lithium metal anode.

### Analysis Example 2: X-ray Photoelectron Spectroscopy (XPS)

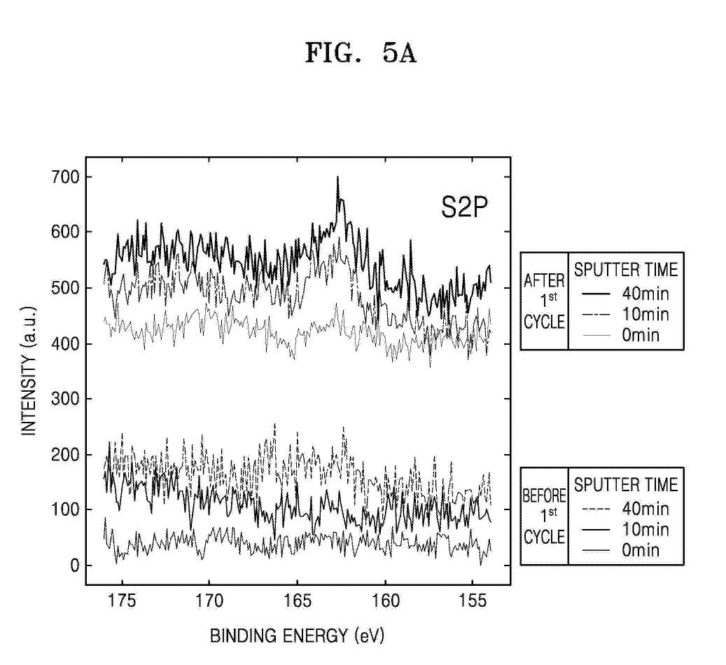

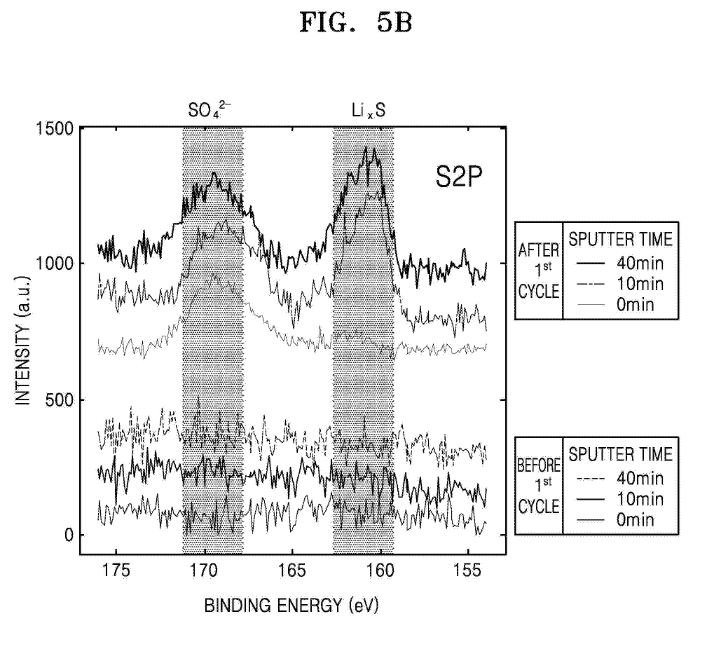

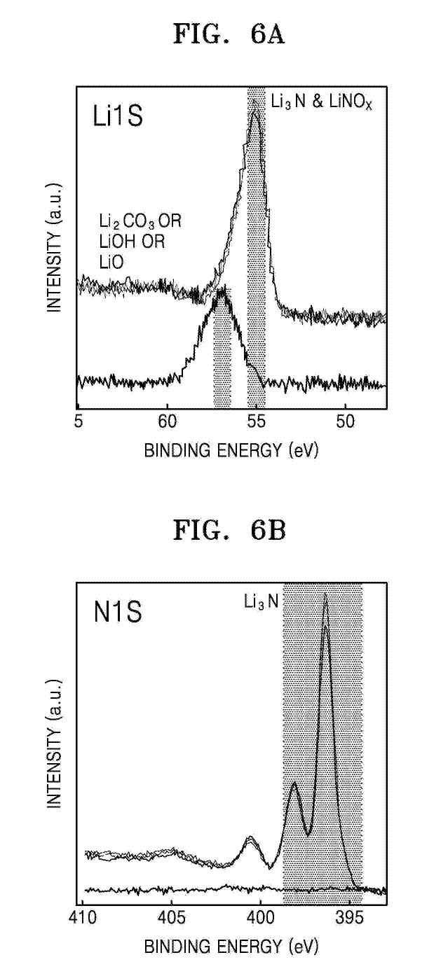

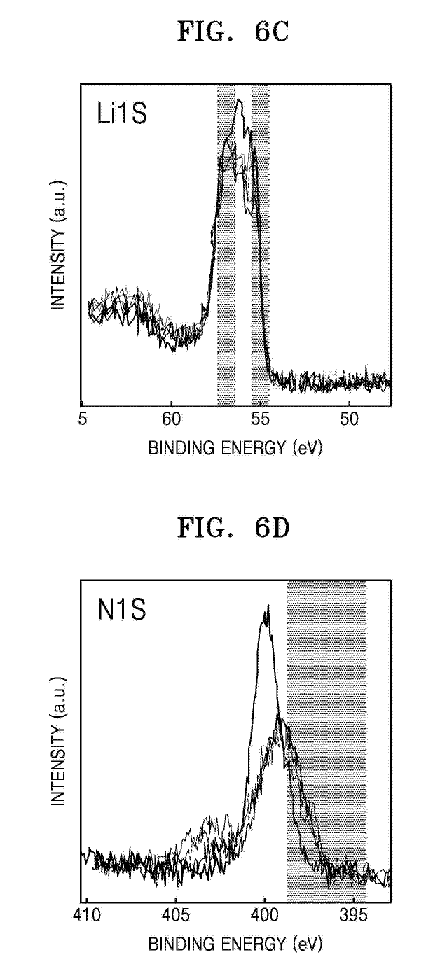

XPS analysis was performed on the surfaces of the protected anode and the anode of the lithium secondary batteries (full cells) prepared according to Example 4 and Comparative Example 2, respectively. Results of the XPS analysis include the S2p spectra that are shown in FIGS. 5A and 5B and the Li1s and N1s spectra that are shown in FIGS. 6A and 6B.

The XPS analysis was performed using a Quantum 2000 (Physical Electronics, Inc.) (where acceleration voltage: 0.5˜15 keV, 300 W, energy resolution: about 1.0 eV, minimum analysis area: 10 micro, Sputter rate: 0.1 nm/min, Sputter time: 0 min, 10 min, and 40 min).

The XPS analysis was performed by charging the lithium secondary batteries (full cells) prepared according to Example 4 and Comparative Example 2 at a constant current of 0.2 C until a voltage is reached at 4.4 V and charged at a constant voltage of 4.4 V until the current reached 0.05 C. Then, the lithium secondary batteries (full cells) were discharged at a constant current of 0.2 C until the voltage reached 2.8 V (formation).

After formation, the lithium secondary batteries (full cells) were charged at a constant current of 1.0 C at room temperature (25° C.) as described above and discharged at a constant current of 1.0 C until the voltage reached 2.8 V. Charging and discharging conditions in this process are referred to as reference charging and discharging conditions and discharge capacity of this process are referred to as reference capacity. The aforementioned charging and discharging process was performed once (1^{st} cycle).

Before and after the 1^{st} cycle of charging and discharging, the lithium secondary batteries (full cells) were disassembled and XPS analysis was performed on the surfaces of the anodes of the lithium secondary batteries (full cells) depending on sputter time (0 min, 10 min, and 40 min).

Referring to FIGS. 5A and 5B, peaks were observed for the lithium secondary battery (full cell) prepared according to Comparative Example 2 at binding energies ranging from about 167 electron volts (eV) to about 172 eV and from about 158 eV to about 164 eV after the 1^{st} cycle. Peak intensities were reduced or no peak was observed for the lithium secondary battery (full cell) prepared according to Example 4 at binding energies ranging from about 167 eV to about 172 eV and from about 158 eV to about 164 eV after the 1^{st} cycle. Peaks observed at the binding energies ranging from about 167 eV to about 172 eV and from about 158 eV to about 164 eV, respectively, provide information about the SO₄²⁻ anion and the LiₓS salt, respectively.

As a result, it may be confirmed that the lithium salt was decomposed in the electrolyte on the surface of the lithium metal anode and did not remain thereon in the lithium secondary battery (full cell) prepared according to Example 4 as compared to the lithium secondary battery (full cell) prepared according to Comparative Example 2. Thus, it may be understood that an amorphous LiₓN layer (where 0.01≦x≦3) is formed on the surface of the lithium metal anode in the lithium secondary battery (full cell) prepared according to Example 4.

FIGS. 6A and 6B respectively illustrate the Li1s and N1s XPS spectra of the lithium secondary battery (full cell) prepared according to Example 4. FIGS. 6C and 6D respectively illustrate the Li1s and N1s XPS spectra of the lithium secondary battery (full cell) prepared according to Comparative Example 2.

The XPS analysis was performed on the surface of the anodes of the lithium secondary batteries (full cells) after disassembling the lithium secondary batteries (full cells) under the reference charging and discharging conditions (where sputter time: 0 min).

Referring to FIGS. 6A to 6D, peaks were observed at a binding energy of about 55 eV in the Li1s spectrum and at a binding energy from about 394 eV to about 399 eV in the N1s spectrum of the lithium secondary battery (full cell) prepared according to Example 4. In the lithium secondary battery (full cell) prepared according to Comparative Example 2, no peak was observed at the binding energy of about 55 eV in the Li1s spectrum and at the binding energy from about 394 eV to about 399 eV in the N1s spectrum. The peak observed at the binding energy of about 55 eV in the Li1s spectrum provides information about Li₃N and LiNOₓ. The peak observed at the binding energy from about 394 eV to about 399 eV in the N1s spectrum provides information about Li₃N.

### Evaluation Example 1: Impedance Characteristics—Interface Resistance, Ion Conductivity, Bulk Resistance, and Charge Transfer Resistance

### 1-1: Interface Resistance

Impedance characteristics of the lithium secondary batteries (full cells) prepared according to Examples 4 to 6 and Comparative Examples 2, 4, and 5 were evaluated at 25° C.

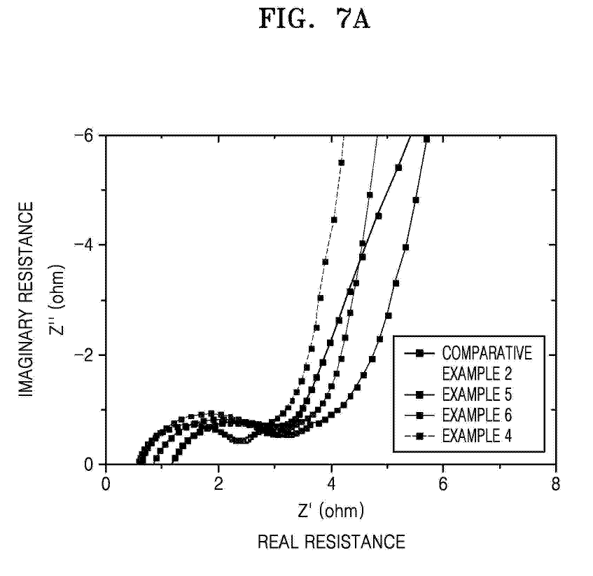

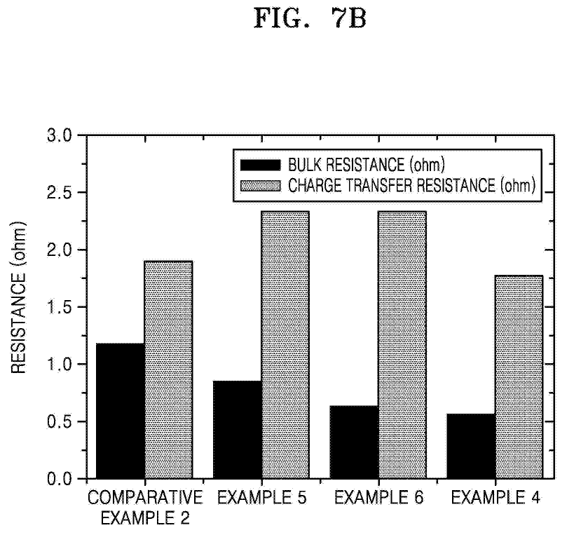

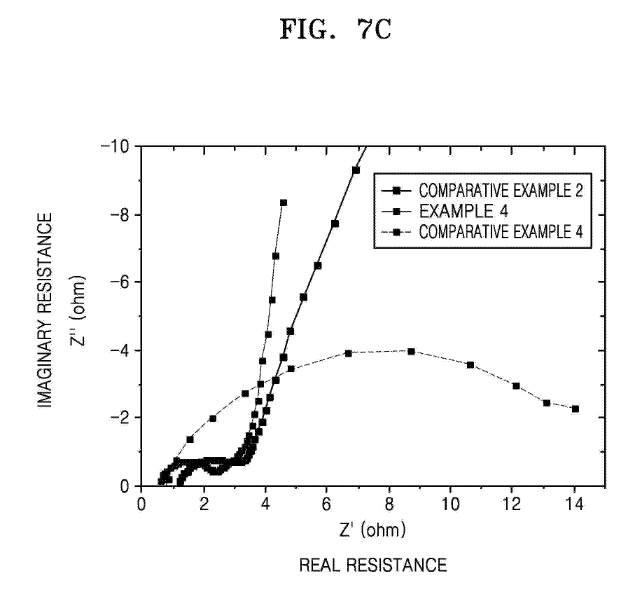

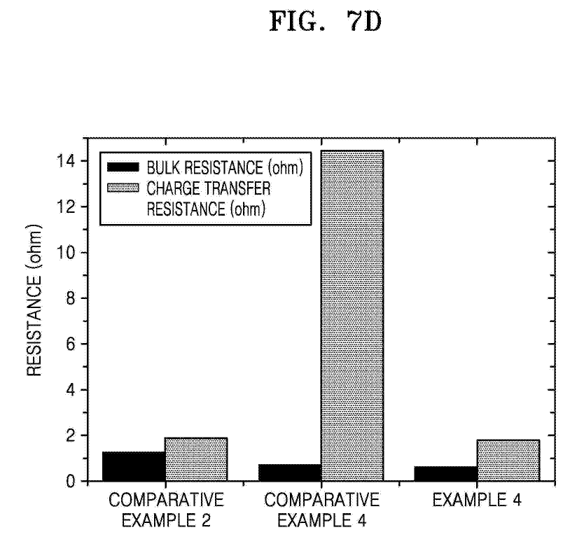

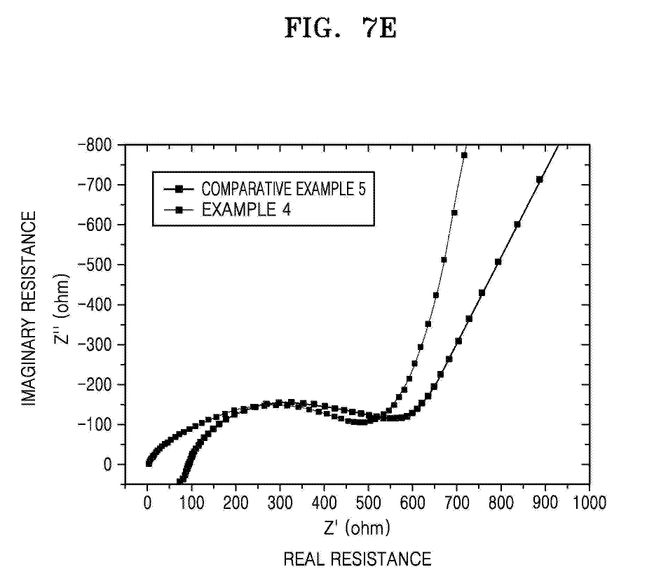

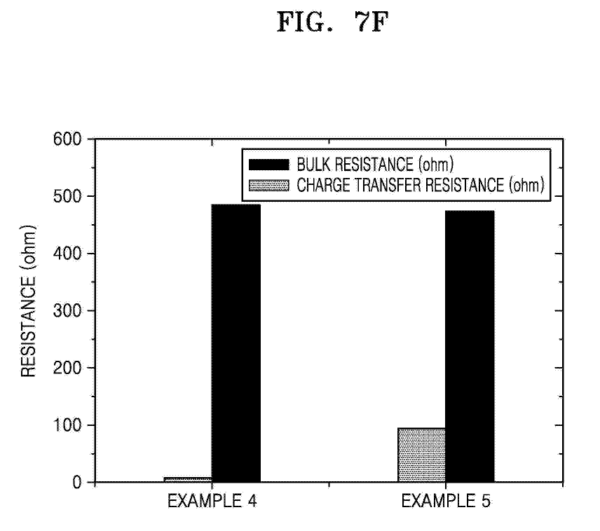

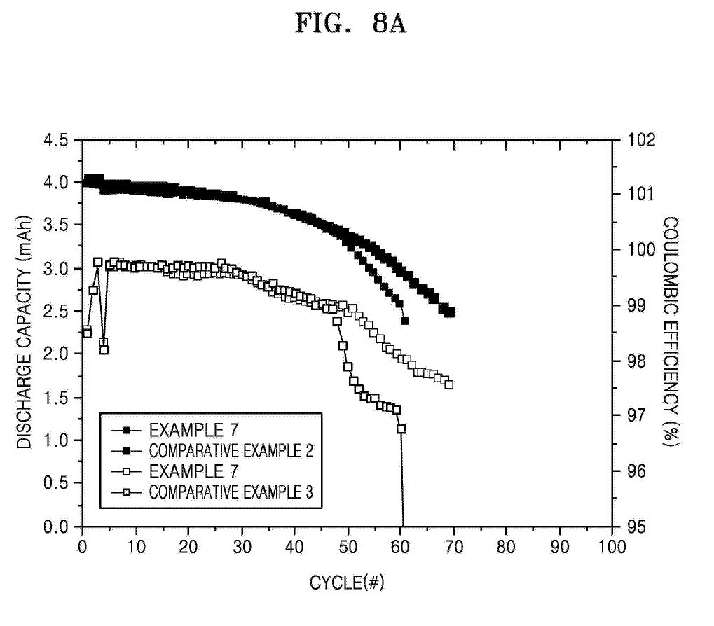

A Solatron SI1260 impedance/frequency analyzer (where frequency range: 1 MHz to 1 Hz and amplitude: 10 mV) was used to measure impedance. The measurement results are shown as Nyquist plots in FIGS. 7A, 7C, and 7E.

In the drawings, interface resistance of an electrode is determined according to a position and a size of a semi-circle. A difference between a left x-axis intercept and a right x-axis intercept of the semi-circle indicates the interface resistance of the electrode.

Referring to FIGS. 7A, 7C, and 7E, the lithium secondary batteries (full cells) prepared according to Examples 4 to 6 have less electrode resistance than the lithium secondary batteries (full cells) prepared according to Comparative Examples 2, 4, and 5 at 25° C.

### 1-2: Ion Conductivity

Ion conductivity of the lithium secondary batteries (full cells) prepared according to Example 4 and Comparative Example 5 was evaluated at 25° C.

Ion conductivity of the (protected) anode of the lithium secondary batteries (full cells) was obtained via Equation 1 below by using a resistance R calculated from an arc of the Nyquist plot of FIG. 7E.

σ=I/(R·A) (where σ: ion conductivity, R: resistance, I: thickness of protected anode, A: electrode area) Equation 1

In Equation 1, the thickness of the protected anode was about 20 μm and the electrode area was about 1.13 cm². Ion conductivities of the protected anodes of the lithium secondary batteries (full cells) prepared according to Example 4 and Comparative Example 5 obtained at 25° C. using Equation 1 above were 2.212×10⁻⁶ siemens per centimeter (S/cm) and 1.930×10⁻⁶ S/cm, respectively.

Ion conductivity of the protected anode of the lithium secondary battery (full cell) prepared according to Example 4 was greater than the ion conductivity of the lithium secondary battery (full cell) prepared according to Comparative Example 5 at 25° C.

### 1-3: Bulk Resistance and Charge Transfer Resistance

Bulk resistance and charge transfer resistance of the protected anodes and anodes of the lithium secondary batteries (full cells) prepared according to Examples 4 to 6 and Comparative Examples 2, 4, and 5 were evaluated at 25° C.

Evaluations of bulk resistance and charge transfer resistance of the protected anode and anode of the lithium secondary batteries (full cells) were performed using x-axis intercepts (for bulk resistance) and radiuses of semi-circles thereof (for charge transfer resistance) in Nyquist plots of FIGS. 7A, 7C, and 7E. The results are shown in FIGS. 7B, 7D, and 7F, respectively.

Referring to FIGS. 7B and 7D, the bulk resistance and the charge transfer resistance of the protected anodes of the lithium secondary batteries (full cells) prepared according to Examples 4 to 6 were less than the bulk resistance and charge transfer resistance of the anodes of the lithium secondary batteries (full cells) prepared according to Comparative Examples 2 and 4 at 25° C.

Bulk resistance of the protected anode of the lithium secondary battery (full cell) prepared according to Example 4 was about 50% of the bulk resistance of the anode of the lithium secondary battery (full cell) prepared according to Comparative Example 2 at 25° C. Charge transfer resistance of the protected anode of the lithium secondary battery (full cell) prepared according to Example 4 was about 7 times less than the charge transfer resistance of the anode of the lithium secondary battery (full cell) prepared according to Comparative Example 2 at 25° C.

Referring to FIG. 7F, the charge transfer resistance of the protected anode of the lithium secondary battery (full cell) prepared according to Example 4 was similar to the charge transfer resistance of the protected anode of the lithium secondary battery (full cell) prepared according to Comparative Example 5 at 25° C. However, the bulk resistance of the protected anode of the lithium secondary battery (full cell) prepared according to Example 4 was less than the bulk resistance of the protected anode of the lithium secondary battery (full cell) prepared according to Comparative Example 5 at 25° C.

### Evaluation Example 2: Charge and Discharge Test—Coulombic Efficiency and Lifespan Characteristics

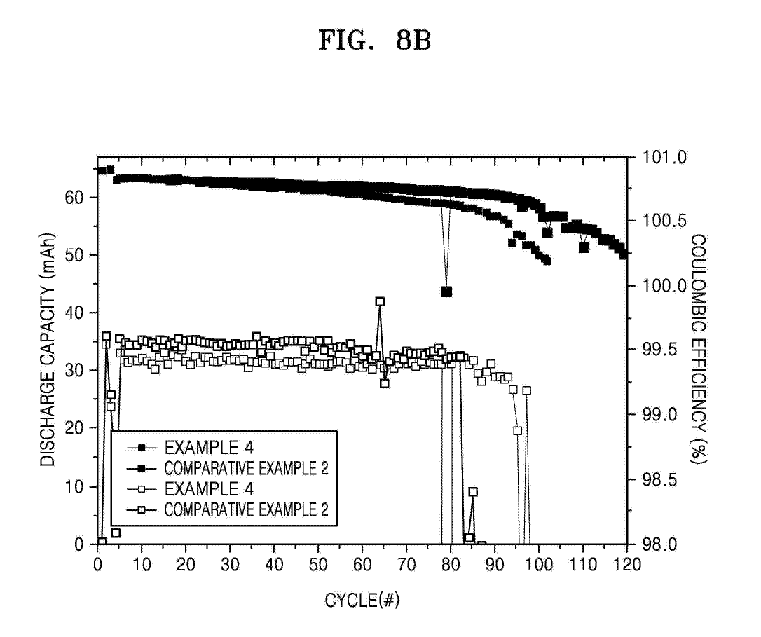

The lithium secondary batteries (full cells) prepared according to Examples 4 and 7 and Comparative Examples 2 and 3 were charged at a constant current of 0.7 C at a voltage range of about 3.0 V to about 4.4 V with respect to lithium metal at room temperature (25° C.) and discharged at a constant current of 0.5 C and 30 mA until the voltage reached a cut-off voltage of 4.4 V. Then, this charging and discharging process was repeated for another 99 cycles to perform the process 100 cycles in total. The results are shown in FIGS. 8A and 8B. In this case, Coulombic efficiency and cycle capacity retention ratio are calculated using Equations 4-1, 4-2, 5-1, and 5-2 below, respectively. The results are shown in Tables 1 and 2 below.

Coulombic efficiency (%)=(discharge capacity of 60^{th} cycle/charge capacity of 60^{th} cycle)×100% Equation 4-1

Coulombic efficiency (%)=(discharge capacity of 80^{th} cycle/charge capacity of 80^{th} cycle)×100% Equation 4-2

Cycle capacity retention (%)=(discharge capacity of 60^{th} cycle/discharge capacity of 1^{st} cycle)×100% Equation 5-1

Cycle capacity retention (%)=(discharge capacity of 100^{th} cycle/discharge capacity of 1^{st} cycle)×100% Equation 5-2

TABLE 1

| | Coulombic efficiency | Cycle capacity retention |
|---|---|---|
| | at 60^{th} cycle (%) | at 60^{th} cycle (%) |
| Example 7 | 98.05752 | 73.6185 |
| Comparative | 96.81353 | 64.2094 |
| Example 2 | | |

TABLE 2

| | Coulombic efficiency | Cycle capacity retention |
|---|---|---|
| | at 85^{th} cycle (%) | at 100^{th} cycle (%) |
| Example 4 | 99.43151 | 92.6069 |
| Comparative | 98.41323 | 77.4253 |
| Example 2 | | |

Referring to Table 1 and FIG. 8A, a Coulombic efficiency of the lithium secondary battery (full cell) prepared according to Example 7 at the 60^{th} cycle was greater than the Coulombic efficiency of the lithium secondary battery (full cell) prepared according to Comparative Example 2. A cycle capacity retention of the lithium secondary battery (full cell) prepared according to Example 7 at the 60^{th} cycle was about 16% greater than the cycle capacity retention of the lithium secondary battery (full cell) prepared according to Comparative Example 2

Referring to Table 2 and FIG. 8B, a Coulombic efficiency of the lithium secondary battery (full cell) prepared according to Example 4 at the 85^{th} cycle was greater than the Coulombic efficiency of the lithium secondary battery (full cell) prepared according to Comparative Example 2. A cycle capacity retention of the lithium secondary battery (full cell) prepared according to Example 4 at the 100^{th} cycle was about 20% greater than the cycle capacity retention of the lithium secondary battery (full cell) prepared according to Comparative Example 2.

As described above, the protected anode according to an embodiment limits and/or prevents direct contact between the lithium metal or lithium alloy and the electrolyte thereby inhibiting formation of a dendrite on the surface of the anode including the lithium metal or lithium alloy. The lithium battery including the protected anode may operate at a high voltage of about 4.0 V or higher. The lithium battery may have a reduced charge transfer resistance and a reduced bulk resistance and suitable ion conductivity and charge/discharge characteristics at room temperature (25° C.).

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A lithium battery comprising:
an anode comprising a lithium metal or lithium alloy;
an ion-conductive amorphous metal nitride layer disposed on a surface of the anode;
a liquid electrolyte; and
a cathode.

2. The lithium battery of claim 1, wherein the ion-conductive amorphous metal nitride layer contacts the anode.

3. The lithium battery of claim 1, wherein the ion-conductive amorphous metal nitride layer covers an entire surface of the anode.

4. The lithium battery of claim 1, wherein the ion-conductive amorphous metal nitride layer has a thickness of about 1 nanometer to about 15 micrometers.

5. The lithium battery of claim 1, wherein the ion-conductive amorphous metal nitride layer comprises a metal nitride represented by Formula 1:
Li^{x}N Formula 1
wherein 0.01≦x≦3.

6. The lithium battery of claim 1, wherein the anode further comprises a compound represented by Formula 2 on at least a portion of the surface thereof:
Li₂₋ₐCO_{3-b} Formula 2
wherein 0≦a<1 and 0≦b<1.

7. The lithium battery of claim 6, wherein an amount of the compound represented by Formula 2 is in a range of about 0.1 mole percent to about 5 mole percent, based on 100 mole percent of a total content of the surface of the lithium metal or the lithium alloy.

8. The lithium battery of claim 1, wherein the liquid electrolyte comprises a non-aqueous organic solvent and a lithium salt.

9. The lithium battery of claim 8, wherein the non-aqueous organic solvent comprises at least one organic solvent selected from a carbonate, an ester, an ether, a ketone, an amine, and a phosphine

10. The lithium battery of claim 8, wherein the non-aqueous organic solvent comprises at least one selected from a carbonate and an ester.

11. The lithium battery of claim 8, wherein the lithium salt comprises a lithium salt represented by Formula 3 below:
LiX₁ Formula 3
wherein X₁ comprises at least one anion selected from BF₄⁻, PF₆⁻, AsF₆⁻, SbF₆⁻, AlCl₄⁻, HSO₄⁻, CH₃SO₃⁻, (CF₃SO₂)₂N⁻, Cl⁻, Br⁻, I⁻, SO₄⁻, PF₆⁻, ClO₄⁻, F₃SO₃⁻, CF₃CO₂⁻, C₂F₅SO₂)₂N⁻, (C₂F₅SO²)(CF₃SO₂)N⁻, CF₃SO₂)₂N⁻, NO₃⁻, Al₂Cl₇⁻, ASF₆⁻, SbF₆⁻, CH₃COO⁻, (CF₃SO₂)₃C⁻, (CF₃)₂PF₄⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, and (O(CF₃)₂C₂(CF₃)₂O)₂PO⁻.

12. The lithium battery of claim 1, wherein a charge transfer resistance between the anode and the liquid electrolyte is at least about 10 percent less than a charge transfer resistance between the anode comprising the lithium metal or the lithium alloy and the liquid electrolyte when in a lithium battery not comprising the ion-conductive amorphous metal nitride layer, wherein the charge transfer resistance is determined by impedance measurement at 25° C. and in a Nyquist plot.

13. The lithium battery of claim 1, wherein a bulk resistance between the anode and the cathode is at least about 10 percent less than a bulk resistance between the anode comprising the lithium metal or the lithium alloy and the cathode when in a lithium battery not comprising the ion-conductive amorphous metal nitride layer, wherein the charge transfer resistance is determined by impedance measurement at 25° C. and in a Nyquist plot.

14. The lithium battery of claim 1, wherein the cathode comprises a cathode active material comprising a compound which intercalates and deintercalates lithium, inorganic sulfur, or a sulfur compound.

15. The lithium battery of claim 1, further comprising a separator disposed between the anode and the cathode.

16. The lithium battery of claim 1, wherein an operating voltage of the lithium battery is about 4 volts or greater.

17. A method of preparing a protected anode, the method comprising:
introducing an inert gas and an oxocarbon gas into a container in which an anode comprising a lithium metal or a lithium alloy is disposed to provide a compound represented by Formula 2 on at least a portion of a surface of the anode; and
exposing the anode, which comprises the lithium metal or the lithium alloy and the compound represented by Formula 2 on the at least a portion of the surface thereof, to a nitrogen gas to prepare the protected anode, wherein the protected anode comprises an ion-conductive amorphous metal nitride layer on a surface thereof:
Li₂₋ₐCO_{3-b} Formula 2
wherein 0≦a<1 and 0≦b<1.

18. The method of claim 17, wherein the exposing is at a temperature of about 10° C. to about 20° C. for about 1 minute to about 120 minutes.

19. The method of claim 17, wherein the ion-conductive amorphous metal nitride layer comprises a metal nitride represented by Formula 1 below:
LiₓN Formula 1
wherein 0.01≦x≦3.

20. The method of claim 17, wherein the ion-conductive amorphous metal nitride layer has a thickness of about 1 nanometer to about 15 micrometers.

21. A protected anode comprising:
an anode comprising a lithium metal or a lithium alloy; and
an ion-conductive amorphous metal nitride layer disposed on a surface of the anode.

22. The protected anode of claim 21, wherein the ion-conductive amorphous metal nitride layer covers an entire surface of the anode.

23. The protected anode of claim 21, wherein the ion-conductive amorphous metal nitride layer has a thickness of about 1 nanometer to about 15 micrometers.

24. The protected anode of claim 21, wherein the ion-conductive amorphous metal nitride layer comprises a metal nitride represented by Formula 1:
LiₓN Formula 1
wherein 0.01≦x≦3.

25. The protected anode of claim 21, wherein the lithium metal or the lithium alloy comprises a compound represented by Formula 2 on at least a portion of a surface thereof:
Li₂₋ₐCO_{3-b} Formula 2
wherein 0≦a<1 and 0≦b<1.
